(19) United States
(12) Patent Application Publication
(10) Pub. No.: US 2015/0269583 A1
(43) Pub. Date: Sep. 24, 2015

(54) DEVICE FOR FACE-KEY PURCHASING

(71) Applicants: Thomas Jason Taylor, San Clemente, CA (US); Reyhan Nihat Pasinli, Aliso Viejo, CA (US)

(72) Inventors: Thomas Jason Taylor, San Clemente, CA (US); Reyhan Nihat Pasinli, Aliso Viejo, CA (US)

(21) Appl. No.: 14/713,265

(22) Filed: May 15, 2015

Related U.S. Application Data
(63) Continuation-in-part of application No. 14/464,628, filed on Aug. 20, 2014.
Application No. 14/464,628 is a continuation-in-part of application No. 14/464,648, filed on Aug. 20, 2014.
Application No. 14/464,648 is a continuation-in-part of application No. 14/223,678, filed on Mar. 24, 2014.
Application No. 14/223,678 is a continuation-in-part of application No. 14/599,839, filed on Jan. 19, 2015.

(51) Int. Cl. G06Q 20/40; G06K 9/00

(52) U.S. Cl. CPC G06Q 20/40145; G06K 9/00288

(57) ABSTRACT

The present invention teaches a purchase enabling database consisting of customer records which each contain 1) sufficient commercial information about a customer to enable an electronic purchase and 2) a face key of electronic facial recognition identity data allowing electronic comparison to a submitted facial identity code candidate. If the facial recognition of the candidate face indicates a match, the individual is able to make a commercial transaction without further exchange of financial information, thus allowing the user/customer to make a purchase. A system embodiment allows a subscribing vendor to embed facekey enablement in their own vending website/software/hardware.

### CROSS-REFERENCE TO RELATED APPLICATIONS

This application claims the priority and benefit of previously filed U.S. patent applications Ser. Nos. 61/881,246, 61/881,287, 14/464,628, 14/223,678, 14/599,839, respectively filed on Sep. 23, 2013, Sep. 23, 2013, Aug. 20, 2014, Mar. 24, 2014, Jan. 19, 2015, and entitled “Social Media Marketing”, “System and Method for Viral Purchasing”, “System and Method for Purchasing by Social Network”, “Voice-Key Electronic Commerce”, and “System and Method for Purchasing by Embedded, Purchase-Capable Video Player”.

### FIELD OF INVENTION

This invention relates generally to a device for electronic commerce and specifically to electronic facial recognition databases.

### STATEMENT REGARDING FEDERALLY FUNDED RESEARCH

This invention was not made under contract with an agency of the US Government, nor by any agency of the US Government.

### BACKGROUND OF THE INVENTION

Modern electronic commerce runs off of the identification code. The code may take the form of a credit card number with CVV code, a PIN, a routing number or other identification but in essence, a numeric identification code is required for electronic business to be transacted.

In most instances, a customer accesses a network such as the Internet by means of an electronic browsing device such as a computer or telephone. The customer's first transaction requires that they deposit with the retailer their personal financial information such as credit card number, address for physical shipment of the products or performance of the service, and so on. More recently, intermediary services have sprung up which hold the customer's financial information. When a purchase is made, the retailer's web page offers to the customer the option of using the intermediary service (such as #Twt2Pay or Paypal®) to complete the transaction, that is, to make the payment. This serves several purposes. It allows the customer to input their information into only single electronic web service, thus reducing the number of times that information is transmitted and the chances of the information being compromised. It allows the retailer to avoid having to gather and safeguard that information.

Significantly, it also renders online commercial activity much faster and more convenient to carry out. This ease of use is very important in online sales, which tend to be made on a more impulse oriented basis than most brick-and-mortar sales.

Usually such services are accessed also through the medium of a web page, that is, the option to use the intermediary payment service is offered by means of a virtual button or the like. Such buttons are in fact merely part of the HTML/XML/XHTML/JAVA coding of most web pages, with plug-ins or modules which are also supported by standards on both the client side and the server side, such as PHP, ASP.net, HTML5, FLASH, Silverlight, and of course other parts of such a system including operating systems, iOS, Android and the like. The intermediary makes the code for the button module available to the retailer, who incorporates it into their web page. The web page itself is normally merely an elaborate coding in HTML/XML/XHTML/JAVA, so this is an extremely easy task to carry out on the part of the retailer's technical staff.

However, whether checkout is by intermediary or directly, it will nonetheless require the user to log in at least once to whichever entity is going to receive and hold the customer's financial data. Thus a customer pushing a ‘PAY USING PAYPAL®’ button will then normally be required to type into their computer their password for that service. While such passwords, especially if the password chosen is simple, may be easier to remember than a credit card number, it is nonetheless more mental clutter for internet shoppers and thus it presents another time barrier to retailers making purchases. In addition, increasingly customers will be accessing website by means of extremely small and portable devices which may feature tiny keyboards, tiny on-screen keyboards for touch screens, or even no keyboard at all. This slows down the customer even further at a moment when the retailer wants everything to be extremely convenient and quick.

It would be preferable to allow retailers to embed, quickly and easily, an extra function in their online shopping cart which would allow greater convenience, especially in the mobile arena.

It would be preferable to provide a method and device which allows customers to check out via facial recognition technology.

It would be preferable to provide a facial-keyed checkout capability which doesn't require the customer to use a special set-top box, a specially downloaded piece of software, or any other specialized purchase module.

Various usages of facial recognition databases (and supporting methods) are known.

Facial recognition has been used in social settings, for example as taught in US2014/0328521 in the name of Colangelo, published Nov. 6, 2014. However, this is a social system rather than a commercial database device, and thus lacks financial data. US 2014/0309865 in the name of Ricci (Oct. 16, 2014) is also a social networking scenario without a commercial database, as is US 2014/0172881 (Petrou et al, Jun. 19, 2014).

More commercially, US 2014/0270409 (Pub. Date Sep. 18, 2014) in the names of Hanna et al teaches facial recognition in prevention of fraud. However, it has a biometric database without financial information.

Similarly, US 2014/0140584 (May 22, 2014) in the name of Lee teaches that a POS system or PC might be used to extract personal information such as gender, age, etc from an image, but is not directed to databases containing financial information.

One use of facial recognition databases is to allow access to a computer network to programmers or the like. US 2014/0037155 in the name of Faria (Feb. 6, 2014) teaches both that a facial recognition system may be used for access control to a place or network and also that it may be used for register confirmation. It even mentions a database with a “register document” therein. However, it also lacks financial information directed to independent purchasing. In general, U.S. Pat. No. 8,548,208 in the name of Schultz, patent date Oct. 1, 2013 shows biometric authorization but once again, lacks financial information of the type associated therewith in the present application. U.S. Pat. No. 8,406,478 (Mar. 26, 2013, Chen et al) falls into the same area.

Typical of other items, U.S. Pat. No. 6,912,312 (Milner et al, Jun. 28, 2005) teaches away from the present invention by using facial recognition to verify financial data, in the case of the '312 patent, a credit card. Obviously it would be advantageous to turn such a process on its head and thus simplify the purchase for the customer. The same is true for another use of facial recognition databases is linked to customer bank accounts so that ATM machines may be accessed more conveniently, such as shown in US 2005/0167482 to Ramachandran et al, published Aug. 4, 2005, which even suggests payments could be made at an ATM

It would be preferable to provide a specialized type of facial recognition database having unique features allowing it to be used for commerce.

### SUMMARY OF THE INVENTION

The present invention teaches a purchase enabling database consisting of customer records which each contain 1) sufficient commercial information about a customer to enable an electronic purchase and 2) a face key of electronic facial recognition identity data allowing electronic comparison to a submitted facial identity code candidate. If the facial recognition of the candidate face indicates a match, the individual is able to make a commercial transaction without further exchange of financial information, thus allowing the user/customer to make a purchase without submitting a credit card number, without a pin, without signing in to an account and without providing further financial information of any kind beyond what is stored in the device of the invention.

In one embodiment, an electronic page such as a web page or the like may allow the user to sign up for the service over the Internet (and make purchases using the Internet as well). Other electronic networks such as closed gardens, electronic storefronts and virtual vendors and the like may use the device of the invention.

In yet another embodiment, the device of the invention may be embodied at a server provided by an intermediary party.

In yet another embodiment, the device of the invention serves as one part of a new and unique method of commerce using facial recognition as a security key. It will be understood that the device of the invention may be used separately from the method of the invention.

These and many other aspects, advantages, embodiments and objectives of the present invention will be understood by reference to the following.

### SUMMARY IN REFERENCE TO THE CLAIMS

It is therefore one aspect, advantage, objective and embodiment of the present invention, in addition to those described above, to provide a transactional device for a customer, the device comprising: 1) electronic facial recognition identity data of such customer; 2) associated with such facial recognition identity data, commercial information sufficient to complete an electronic purchase transaction, 3) a purchase processor able to receive contemporaneous facial data from such personal electronic device camera and then to complete the electronic purchase transaction using only the commercial information in the record without additional financial data being required.

It is therefore one aspect, advantage, objective and embodiment of the present invention, in addition to those described above, to provide a transactional device for a customer, wherein: the customer record is one entry in a database having a plurality of customer records; the transactional device and database are embodied in a machine readable and non-volatile medium accessible to a computer processor; the transactional device is electronically remotely accessible.

It is therefore one aspect, advantage, objective and embodiment of the present invention, in addition to those described above, to provide a transactional device for a customer, further comprising: a facial comparison module operative to compare: 1) a facial identity code candidate provided by such customer at a time of purchase to: 2) the electronic facial recognition identity data of such customer.

It is therefore one aspect, advantage, objective and embodiment of the present invention, in addition to those described above, to provide a transactional device for a customer, further comprising: an electronic purchase device, the purchase processor embedded upon such electronic purchase device, wherein the electronic purchase device further comprises: one member selected from the group consisting of: the purchase page of the electronic retailer; the website of the electronic retailer; a purchase page provided by the biometric facekey engine; a dedicated POS station of the electronic retailer; an electronic browsing device of the electronic retailer having thereon POS programming; a vending machine; a dedicated purchase kiosk and combinations thereof.

It is therefore one aspect, advantage, objective and embodiment of the present invention, in addition to those described above, to provide a method of electronic commerce offered by an electronic retailer having an electronic purchase device, for use by a customer having an electronic browsing device having a camera, the method comprising the steps of: providing a database having a plurality of records, each record associated with a single customer, each record having commercial information associated with such customer which commercial information is sufficient to complete a purchase transaction; each record further having biometric facial identity information associated with such customer; providing a product/service for purchase by such customer; transmitting to such customer a purchase page of the electronic retailer; offering such customer the option of facekey checkout and proceeding with the following steps if the customer elects facekey checkout activating such camera on such customer's electronic browsing device; recording the customer's facial identity code candidate; transmitting the facial identity code candidate to a facial checkout portal; submitting the facial identity code candidate to a biometric facekey engine for testing; comparing the facial identity code candidate to the biometric facial identity information associated with such customer in the database; based upon the results of the comparisons of the facial identity code candidate to the biometric facial identity information associated with such customer, assigning a test outcome status to the identity code candidate; determining if the test outcome status is acceptable to such electronic retailer; if the test outcome status is acceptable to such electronic retailer, completing a purchase using the commercial information associated with such customer, including providing the service/shipping the product; if the test outcome status is not acceptable to such electronic retailer, determining if the test outcome status merits raising a fraud detection flag; if the test outcome status does not merit raising a fraud detection flag, determining if such electronic retailer wishes to offer such customer a chance to retry the facekey checkout and if so, returning to the step of offering such customer the option of facekey checkout.

It is therefore one aspect, advantage, objective and embodiment of the present invention, in addition to those described above, to provide a method of electronic commerce offered by an electronic retailer, for use by a customer having an electronic browsing device having a camera, further comprising the first step of: embedding upon such electronic purchase device a facekey recognition module.

It is therefore one aspect, advantage, objective and embodiment of the present invention, in addition to those described above, to provide a method of electronic commerce offered by an electronic retailer, for use by a customer having an electronic browsing device having a camera, wherein such electronic purchase device further comprises: one member selected from the group consisting of: the purchase page of the electronic retailer; the website of the electronic retailer; a purchase page provided by the biometric facekey engine; a dedicated POS station of the electronic retailer; an electronic browsing device of the electronic retailer having thereon POS programming; a vending machine; a dedicated purchase kiosk and combinations thereof.

It is therefore one aspect, advantage, objective and embodiment of the present invention, in addition to those described above, to provide a method of electronic commerce offered by an electronic retailer, for use by a customer having an electronic browsing device having a camera, wherein the step of determining if the test outcome status is acceptable to such electronic retailer further comprises: returning the test outcome status to such electronic retailer for such determination of acceptability to such electronic retailer.

It is therefore one aspect, advantage, objective and embodiment of the present invention, in addition to those described above, to provide a method of electronic commerce offered by an electronic retailer, for use by a customer having an electronic browsing device having a camera, wherein the step of providing a database having a plurality of records, further comprises: providing an online commerce site; providing a registration process in turn comprising the steps of: offering to such customer the opportunity to register for facekey checkout; if such customer accepts the opportunity to register for facekey checkout, creating the record associated with such customer; obtaining from such customer the customer's commercial information and associating that commercial information with such customer in the record; activating such camera on such customer's electronic browsing device; recording biometric facial identity information; transmitting to the facekey checkout portal the biometric facial identity information; associating the biometric facial identity information with such customer in the record, including with the customer's commercial information.

It is therefore one aspect, advantage, objective and embodiment of the present invention, in addition to those described above, to provide a method of electronic commerce offered by an electronic retailer, for use by a customer having an electronic browsing device having a camera, further comprising the step of associating an exact recording information of the biometric facial identity information with such customer in the record, and wherein the step of comparing the biometric facial identity information further comprises comparing exact image recording information of the facial identity code candidate to the exact facial identity code candidate information associated with such customer.

It is therefore one aspect, advantage, objective and embodiment of the present invention, in addition to those described above, to provide a method of electronic commerce offered by an electronic retailer, for use by a customer having an electronic browsing device having a camera, wherein the test outcome status is one member selected from the group consisting of: a first status of match, a second status in which there is no match, a third status in which there is an exact image match, a fourth status in which such customer's facial identity code candidate included an obscured face, and combinations thereof.

It is therefore one aspect, advantage, objective and embodiment of the present invention, in addition to those described above, to provide a method of electronic commerce offered by an electronic retailer, for use by a customer having an electronic browsing device having a camera, wherein the biometric facial identity information further comprises: a complete record of the biometric facial identity information, a hash of the biometric facial identity information, compressed/encoded biometric facial identity information, parity bit checking of the biometric facial identity information, and combinations thereof.

It is therefore one aspect, advantage, objective and embodiment of the present invention, in addition to those described above, to provide a method of electronic commerce offered by an electronic retailer, for use by a customer having an electronic browsing device having a camera, wherein the commercial information associated with a customer further comprises one member selected from the group consisting of: credit card number, credit card security codes, credit card billing address, credit card name, bank account number and routing number, other financial data, shipping address for the aforementioned physical step of shipping the product, performance address for the aforementioned physical step of performing a service, demographic data, electronic commerce history and combinations thereof.

### BRIEF DESCRIPTION OF THE DRAWINGS

FIG. 1 is a frontal view of a face showing a small number of exemplary dimensions potentially usable in facial recognition.

FIG. 2 is a frontal view of the same face with a small tilt (8 degrees).

FIG. 3 is a frontal view of the same face with a scale issue due to distance.

FIG. 4 is a slight elevational frontal view of the same face demonstrating an exaggerated lean distortion.

FIG. 5 is a profile view of the same face.

FIG. 6 is a frontal view of the same face with a different expression, dark glasses and drastic changes in facial and cranial hair.

FIG. 7 is a table showing construction of a face key.

FIG. 8 is a face key based upon the measurements shown in FIG. 7.

FIG. 9A is a block diagram of the device of the system in a database embodiment.

FIG. 9B is a block diagram illustrating a purchase (in this case, in a brick-and-mortar format) using the device of the system.

FIG. 10A is a block diagram illustrating the embedding of the various levels of purchase platforms.

FIG. 10B is a block diagram illustrating the various environments in which a customer might find the device of the invention embedded.

FIG. 10C is a block diagram of a system and apparatus of the invention showing the environment in which it might operate.

FIG. 11 is a flow chart of the purchase operations of the system/apparatus and also of the method embodiment of the invention.

FIG. 12 is a flow chart of the registration process of the system/apparatus and also of the method embodiments of the invention.

FIG. 13 is a table of flags returned by the invention to a retailer, showing the outcome of face key testing.

FIG. 14 is a simplified black diagram of an individual customer record according to the invention.

### INDEX OF REFERENCE NUMERALS

Upper face portion (enlarged vertically) A
Lower face portion (reduced vertically) B
Face 100
Interocular distance 102
Cheekbone shape 104
Width of nose 106
Length of jawline 108
Cheekbone shape 204
Length of jawline 308
Interocular distance 402
Width of nose 406
Cheekbone shape 504
Interocular distance 602′
Cheekbone shape 604
Width of nose 606
Length of jawline 608′
Expression (different) 610′
Facial measurement 1 702
Facial measurement 2 704
Facial measurement 3 706
Facial measurement 4 708
Additional facial measurements 710
Name and simplified facekey string 802
Financial information half of record 902
Facekey data half of record 904
Purchase engine using financial information 906
Vendor 908
Internet device programmed as POS 910
Customer 912
Product 914
Camera 916
Network 1000
Vendor sales platform 1001
Portal 1002
Purchase platform embedded therein 1003
Facial recognition engine 1004
Purchase engine embedded therein 1005
Financial database parts 1006
Facial recognition database parts 1008
Electronic Service/Retailer 1010
Checkout page (XML, etc) 1012
Consumer/Buyer 1014
Browser (supports XML, etc) 1016
Physical transfer of item/perform service 1018
Camera 1020
Customer 1021
Facekey purchase database 1022
Vendor purchase page 1024
Vendor webpage 1026
Purchase page provided by database 1028
POS (traditional cash register) 1030
Internet device programmed as POS 1032
Kiosk 1034
Vending machine 1036
Pre-purchase activity (shopping) 1100
Transmission of purchase page
(HTML, XML, JAVA, FLASH, etc) 1102
Consumer choice 1104
Turn on camera 1106
Record facial identity code candidate 1108
Transmit candidate code to retailer 1110
Forward candidate code to portal 1112
Submit candidate code to engine for testing 1114
Compare face expression to face expression
   associated with customer identity 1116
Compare photographic faceprint to faceprint
   associated with customer identity 1118
Compare biometric faceprint to faceprint
   associated with customer identity 1120
Determine test outcome, flag status 1-5 1122
Return status to portal 1124
Return status to retailer 1126
Status is acceptable to retailer? 1128
Complete transaction 1130
Offer retry 1132
Registration offer from retailer/portal 1200
Consumer decision 1202
Request face identity code 1204
Activate camera 1206
Return face identity code to retailer 1208
Return face identity code to portal 1210
Direct face identity code to FK engine 1212
Database financials and faceprint associated
with consumer identity 1214
Facial/expression match, status 1 1300
No match, status 2 1302
EXACT (photographic) match, status 3 1304
Obscured face, status 4 1306
. . . Other statuses, status 5+ 1310
record 1400
customer name 1402
registration faceprint 1404
faceprint id information 1406
id information 1408
status flags 1410-1420
interarch distance 1422
ineroccuclusal distance 1424
interoccular distance 1426
interpupillary distance 1428
nose length 1430
nasal width 1432
cheekbone shape (left) 1434
mouth width 1436
jaw length 1438
skin tone 1442
credit card number 1444
credit card security codes 1446
credit card billing address 1448
credit card name 1450
bank account number 1452
bank routing number 1454
other financial data 1456
shipping address 1458
performance address 1460
demographic data 1462
electronic commerce history 1464

### DETAILED DESCRIPTION

Glossary

Facial recognition in general refers to the electronic process of testing a candidate image, or a hash or a selection of data from such an image, against another image, both faces, in order to attempt to determine if the two faces are the same. This may occur in a single frame of a video recording or it may be a single digital image.

Commonly, facial recognition relies upon the locating within an image of certain distinctive features or landmarks of the human face. The outer corners of the mouth and eyes, the inner corners of the eyes, the pupils, cheekbones, the width of the nose and various angles relating to eyes, cheeks, nose, mouth and cheekbones all can be significant landmarks. The examples herein are largely this traditional method, however, the invention is in no way limited to feature recognition and the use of algorithms therein: any of the techniques below may be employed in the preferred embodiment, however, in alternative embodiments certain techniques may be prohibited.

A photometric system on the other hand determines various values from a facial image (skin tones, relationships, etc) and then applies a statistical algorithm to the determination of whether a face matches a reference face.

Three dimensional facial recognition attempts to determine the entire shape of a face in three dimensions. The problem of individual's moving their heads is one that has bedeviled facial recognition software for quite some time, since an individual's profile can bear little resemblance to their front exposure. Deviations of much less than 45 degrees can throw off a facial recognition system designed to analyze frontal views only. Three dimensional mapping of a face compensates for this problem. It also handles issues of changes in lighting as well.

Skin texture alone can also be used for analysis, since the texture of an individual's facial skin may be as unique as a fingerprint.

As used herein a “facekey” can be either a particular object or a method of purchasing.

The first definition of facekey refers to a record in a consistent format which defines the features of a face. Thus, in the three dimensional methods, a facekey might be a record which includes the information that an individual's nose projects by 1.1 inches at the base and 0.3 inches at the bridge. In a photometric system the facekey construct might be a mathematical distillation or even simply a computational “hash” (a specific computational operation) of certain variables about the face (ratio of height to width, comparison of skin tone at the forehead to color of the pupils, etc). The facekey may be complete set of files in a complex and automatically self-adjusting data structure or it might be as simple as a string of numbers.

The second definition as used herein may refer to a process, which makes use of the device of the invention, to make purchases using the customer's face as their security data. Thus a face becomes the equivalent of a credit card number or a PIN and the user need not enter the information each time they make a purchase.

An electronic service/retailer as defined herein may purvey physical goods (books, clothing, electronics and so on), electronic goods (video, music, etc), services either physical or online (a maid service, accounting, etc). Sales/purchases made may be actual sales of title in goods, or may be contracts for services, licenses to playing of entertainment and so on. The crucial fact is that the retailer has an online shopping presence which includes a checkout page (in HTML, XML, etc). At this checkout page the customer is presented with an electronic point-of-sale and money actually changes hands, being transferred from one credit account or bank account to another. This transfer of money, which may be represented by cash, can in fact include within the scope of the invention the physical transfer of cash money by electronic means and withdrawal.

One additional step within the scope of the invention may be the transfer of money, followed by that withdrawal, thus effecting the physical moving of money.

Consumer/Buyer might more accurately be represented by their electronic browsing device: a smart telephone, a tablet, a computer, or even a dumb telephone terminal. This personal electronic device has a camera operable to take an electronic picture/photograph of the user/customer and transfer that the facial recognition engine.

As used herein a Browser supports common page transfer protocols such as HTML, XML, XHTML, JAVA and the like, by which means webpages may be easily displayed on the electronic browsing device.

Physical transfer of item/perform service/transfer of money is seen to occur outside of the electronic context, that is, the present invention results in the transfer of tangible physical items such as diamonds, tires, etc. It may further represent a service provider travelling to a location chosen by the customer and performing a service at that location.

As used herein, “financial information” specifically refers to financial information necessary to make the transaction. Thus, a credit card number and related information would be the prototypical example of this, as would a bank routing number and account number. In any case, the point is that sufficient information is contained in a database that the customer need not enter any further information nor re-enter the databased information. Linkage of such information to a face key is unique to the invention.

As used herein, the term “electronic purchase device” may mean any of a variety of common methods of checking out of a vendor, whether the vendor is brick and mortar or strictly online. Thus the electronic purchase device may be a shopping cart functionality such as might be used on the Amazon® website, or it might be considerably more. It might be an embedded purchase function such at #Twt2Pay or Paypal®, or others.

In addition to being the purchase page of the electronic retailer or more generally the website of the electronic retailer the overall purchase functionality may be provided by means of a purchase page provided by the biometric facekey engine, which may be a service to which the vendor/retailer subscribes. Beyond that, the functionality of the present invention may be embedded within a dedicated POS station of the electronic retailer or even an embedded POS station of a brick-and-mortar retailer.

And beyond even that more modern methods of providing the electronic purchase device on which the present invention may be embedded include the use of an electronic browsing device (such as an iPad®, other tablet computer, smart telephone and so on) owned by the electronic retailer and having thereon POS programming, or even backward compatibility to such things as a vending machine, a dedicated purchase kiosk (for electronic goods like song downloads, etc, or for printing, etc etc).

Glossary End

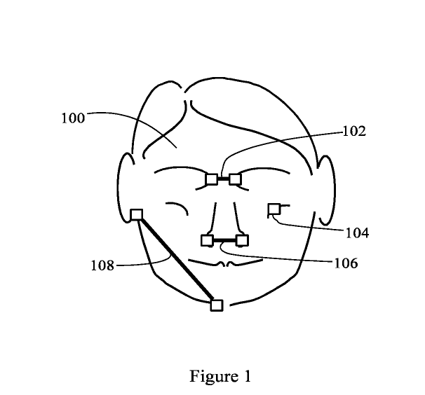

FIG. 1 is a frontal view of a face showing a small number of exemplary dimensions potentially usable in facial recognition. Face 100 has a large number of landmarks which might be used in the “facial features” method of facial recognition deployment. Interocular distance 102 as measured at the inner vertex of each eye (other measurements of eye distance include interpupillary distance, measurement between outer vertices, measures of depth of orbital sockets, color of eyes, arch of brows and so on and so forth. It will be understood that any suitable method of facial recognition may be used, whether it is a landmark method or otherwise.

Cheekbone shape 104, width of nose 106 and length of jawline 108 are additional exemplary facial feature measurements.

FIGS. 2 through 5 display various issues in facial recognition. FIG. 2 is a frontal view of the same face with a small tilt. Although the angle depicted is only 8 degrees, it is sufficient to render the face configuration different: the eyes are no longer level to one another, an improper jaw measurement might show each half of the jaw being a different length and so forth: cheekbone shape 204 is obviously different if no account is made for the angle. In practice, a baseline is established which determines the tilt of the face and this baseline is then applied to all measurements.

FIG. 3 is a frontal view of the same face with a scale issue due to distance: the individual shown is now further away from the camera. Obviously a measurement of eye-to-eye distance which failed to account for this would be fatally flawed, or a measurement of the length of the jawline 308. In practice, a baseline (such as the height of the head) is used to create ratios rather than pure measurements, or to carry though to measurements corrected for distance.

FIG. 4 is a slight elevational frontal view of the same face demonstrating an exaggerated lean distortion.

Upper face portion A has been enlarged by the individual leaning toward the camera, while the lower face portion B has been visually narrowed until the individual is not recognizable by artificial means. Note that even facial shapes have been changed by this effect, so pure ratios such as used with scale issues (FIG. 3) would not even suffice. (In this particular case the degree of ensuing distortion has been vastly exaggerated compared to real photographs.)

As an example of the issues, interocular distance 402 appears larger while width of nose 406 appears smaller when compared to FIG. 1. Compared to one another in a ratio, the incorrect determination would be reached that this was a different face when in fact the customer/user merely faced a camera which had been badly placed in the vertical dimension.

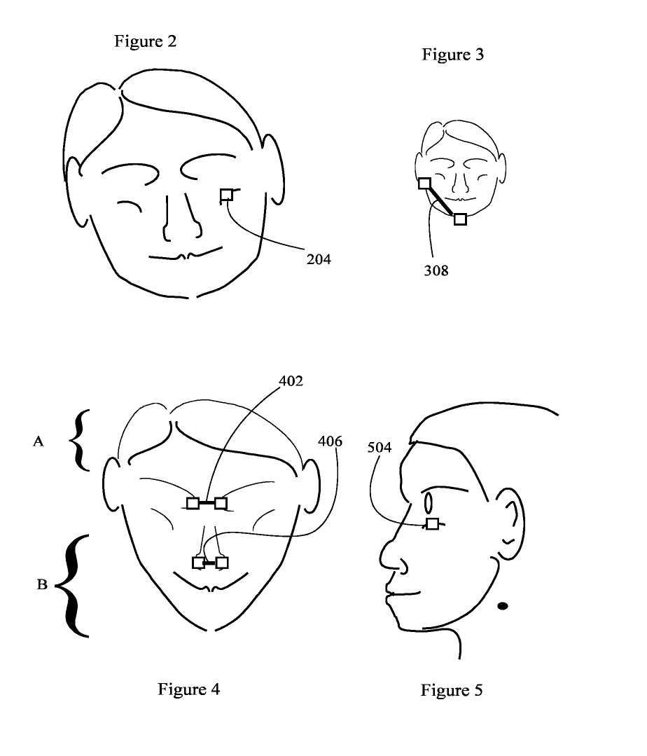

FIG. 5 is a profile view of the same face. Obviously many landmarks, such as those relating to bilateral symmetry of the human face, are now obscured. Others might be impossible to determine and even landmarks which might still be seen, such as cheekbone shape 504, will still have different shapes. In practice two dimensional facial recognition technology may only be suitable in embodiments of the invention in which the user is asked to please face the camera directly. More modern three dimensional facial recognition can be practiced with a single camera by means of multiple shots of the face at different angles.

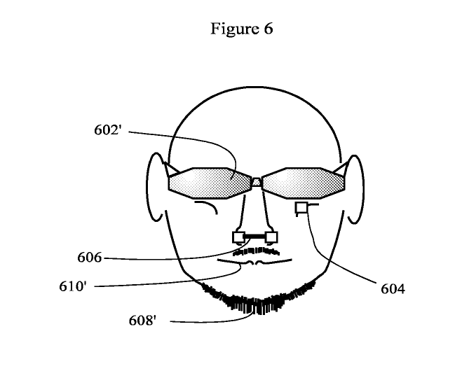

FIG. 6 gives the immediately impression is that this is a different face, however, this is the same individual as shown in FIG. 1. This is a frontal view of the same face with a different expression, dark glasses and drastic changes in facial and cranial hair. While this may seem like an unlikely degree of facial change (rather as if the individual were trying to obscure their appearance) in fact for purposes of the present invention, which is a convenience offered to customers of electronic vendors, this sort of change is more likely to occur as a result of time, a life-style change, a change of habit or companions and so on and so forth. Despite these changes, facial recognition technology can still be used to determine if an image is that of an individual. Thus interocular distance 602′ is simply impossible to determine, but cheekbone shape remains unobscured and the same (604). The width of nose 606 is still as it was, even if the length of the jawline 608′ is obscured by the facial hair.

One issue this shows is quite subtle: expression 610′ is subtly different, not enough for a human being to notice without observation but enough to throw off a simple algorithm based facial recognition device. (The individual is simply smiling a bit less.)

These changes are in fact everyday occurrences, and not the most dramatic changes which individuals make: cosmetic surgery can have a much much more drastic impact on a face, for example, a face-lift or the like.

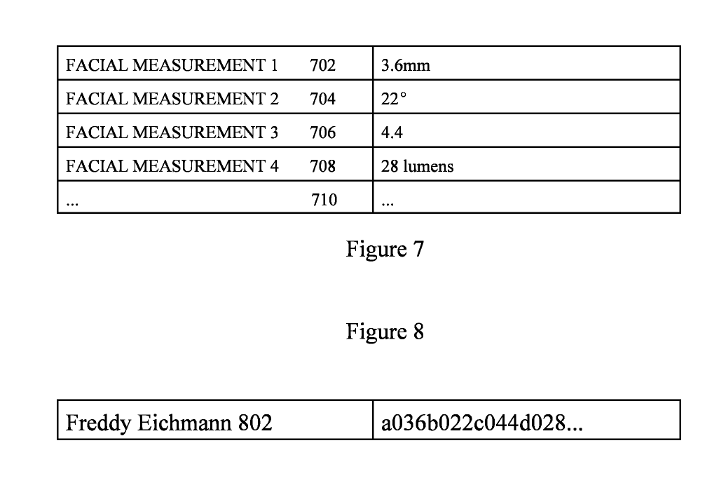

FIG. 7 is a table showing construction of a face key. In this case a vastly simplified landmark system is being used, however, in practice a combination of methods is more likely which includes landmarks, scale factors, angular measurements, use of skin tone and skin patterns, and so on and so forth. While this will then be shown combined in an algorithmic fashion a statistical approach or fuzzy logic approach is at least as likely if not more so in alternative embodiments of the invention.

Facial measurements 1 through 4 (702 through 708) as well as additional facial measurements 710 are shown. These are shown as a combination of dimensions in distance, angles, dimensionless ratios, lumens and the like but in reality the factors will be much more numerous and much more specific.

FIG. 8 then is a face key based upon the measurements shown in FIG. 7. This face key is extremely simple: a mere string of numbers concatenated. As noted earlier, in the glossary section, the facekey may be a complete set of files in a complex and automatically self-adjusting data structure. Thus a more realistic facekey embodiment might have fields which are added as further data is acquired, so that an individual registering with a single frontal snap might have a limited set of data but the same individual, caught in some context in a semi-profile or full profile view, or using a different expression or hair-style, or simply scanned by a different facial recognition chip set in a different personal electronic device, might then have their record's data structure expanded to accommodate the additional fields for the new facekey information which can be gleaned from the new data.

The first part of the database of the invention is showing massively simplified in FIG. 8, with this part 802 of the record having only person's name and their simplified facekey string.

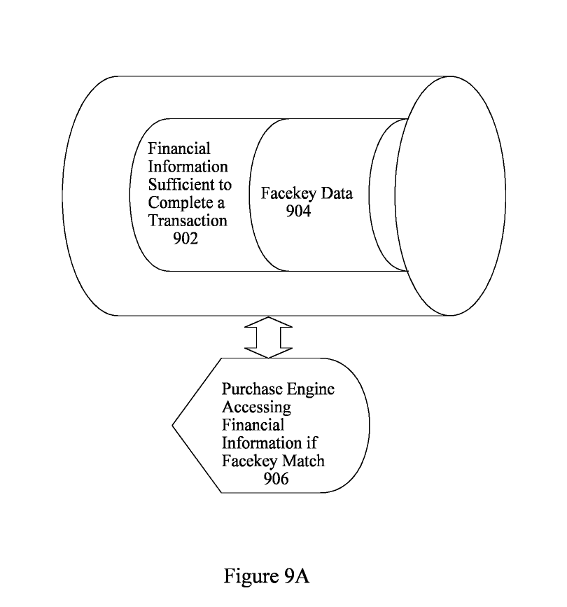

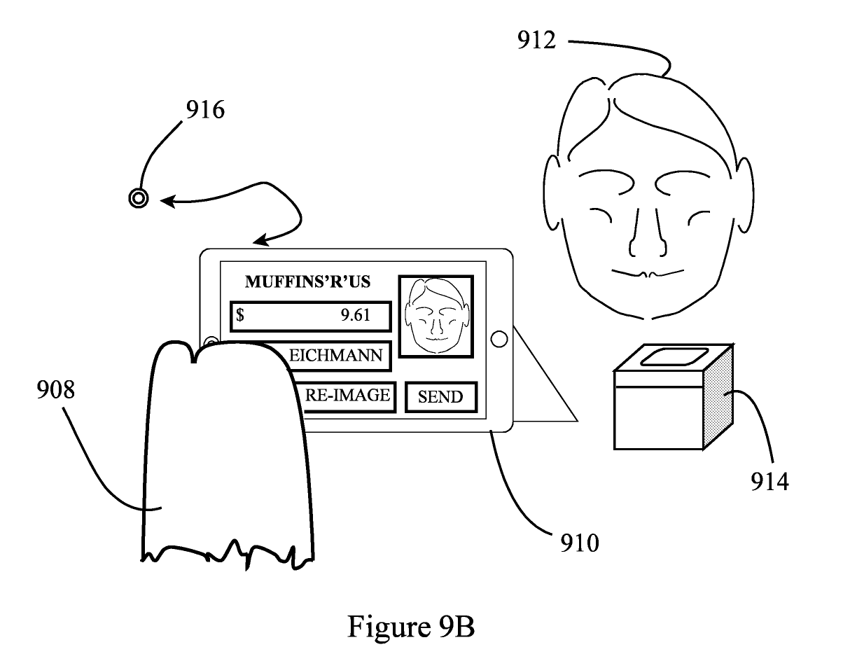

FIG. 9A is a block diagram showing a database according to one preferred embodiment and best mode now contemplated for carrying out the invention. The database has a record within it (database shown as a direct access memory device, the record shown as a two part stored data symbol). The first part of the record is the financial information 902. This information is by itself sufficient to carry out a transaction. For example if the information is a credit card number, then the information 902 also includes the CVV code, zip code of the billing address and the expiration date, all of which are commonly required as security PINs for use of a credit card.

The other half of the record is the facekey data part 904. This may consist of a sub-record as depicted in FIG. 8, or a hash, a complex data structure as discussed or any other facial recognition data sufficient to allow a valid and secure comparison with a candidate image submitted as the security code for a transaction.

Finally, the device of the invention operates to complete a transaction using a purchase engine 906 which accesses the financial information 902 if the comparison made by the engine is verified.

It will be seen that these components need not be divided up in this manner. The comparison may be embedded within the record itself, the purchase function can be located in a different environment (such as the vendor's server) and so on.

9B is a block diagram illustrating a purchase (in this case, in a brick-and-mortar format) using the device of the system. Vendor 908 is using an internet device (such as an iPad®, an Android®, Linux® or Windows® PC tablet computer) programmed as a POS (point of sale station) 910. It may be seen that the camera 916 (which is actually on the reverse (unseen) side of the device 910) is presently imaging customer 912, who is purchasing product 914.

If the face of customer 912 matches the face on file in the database then the customer's financial data in the database is accessed and the purchasing engine finishes the transaction without requiring further financial data.

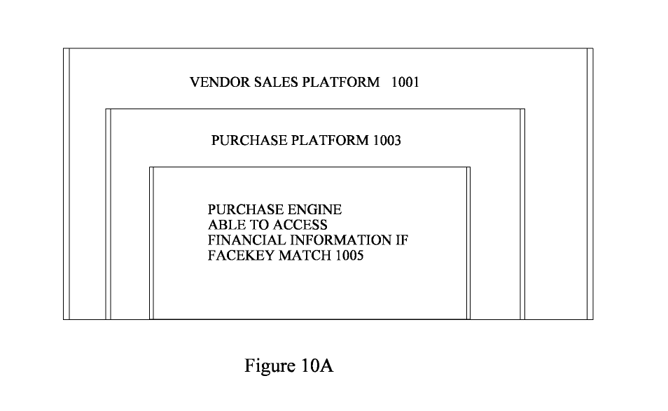

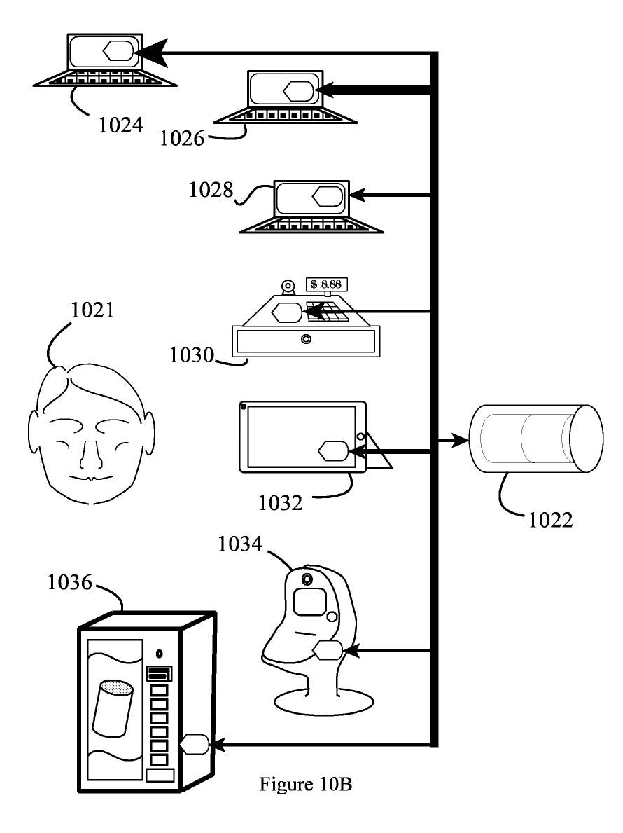

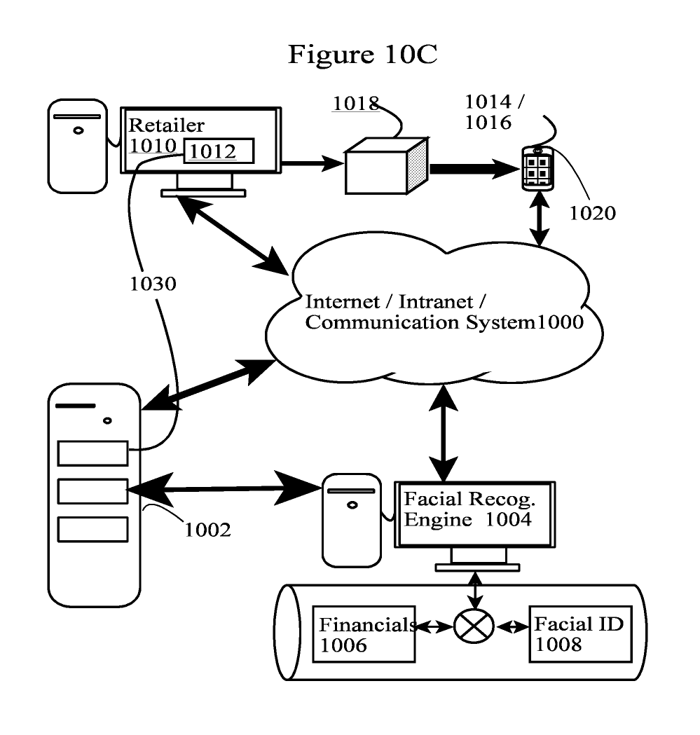

FIG. 10A is a block diagram illustrating the embedding of the various levels of purchase platforms. Thus the vendor sales platform 1001 may be vendor specific purchase page on the internet, however, it might be the website as a whole, a POS, a vending machine, etc.

It has a purchase platform embedded therein 1003. This might be a POS software suite such as those offered by Cisco Systems (for example in a traditional cash register/POS) or it may be offered by Square Registry (for example for use with a smart phone operating as a POS), or it may be #Twt2Pay, etc. Regardless, it in turn has purchase engine 1005 embedded therein, thus allowing a vendor to utilize the system without having departed from the orbit and business relationships with their usual vendors of purchasing platforms.

FIG. 10B is a block diagram illustrating the various environments in which a customer might find the device of the invention embedded. A communication backbone is assumed, for example, an electronic network. Customer 1021 will see cameras on a number of common sales platforms. For example, the customer's own laptop computer, or another device, may have thereon a

vendor purchase page 1024 provided by a payment services company, or vendor webpage (more generally) 1026, or a specific purchase page or functionality provided directly by the database vendor 1028, or the customer 1021 may be at a POS (traditional cash register) 1030, an internet device programmed as a POS 1032, a specialized kiosk 1034 or a vending machine 1036.

Regardless, all of these devices may connect through the backbone to the facekey purchase database 1022. Note that for economic efficiency, the database 1022 may be centralized in a third party “facekey service provider” to which vendors, or purchase platform vendors, software vendors, payment processors and the like subscribe.

FIG. 10C is a block diagram of a system and apparatus of the invention showing the environment in which it might operate.

Network 1000 may be any network as described previously: the Internet, an Intranet, a closed garden app system, a retail system, and so on.

Portal 1002 may represent a third party which collects subscribers (customers) to the system, for example as part of a social networking or social network purchasing system and offers its services to the retailers 1010/1012.

Facial recognition engine 1004 represents one of the three important parts of the device of the invention. The engine 1004 is connected to the internet and therethrough to the camera 1020 on the customer's personal electronic device 1014/facekey purchase app 1016. The engine is operative to compare the facial ID or facekey information 1008 in the database to the candidate submitted at the time of purchase by the camera 1020. If the status of this comparison is acceptable to the vendor, then the device of the invention is further operative to use the financial information 1006 in the customer's record to complete the transaction.

As a result of this device, the customer need not enter any security code, no credit card number is needed and so on. In effect, the customer's face becomes the security code which accesses their bank account or credit line and causes the transaction to complete.

Financial database parts 1006 and facial recognition database parts 1008 represent additional parts of the important core of the invention: they are shown combined by the

### flow chart symbol:

### |

used to indicate a summing of the two parts of the database. The combination of these two parts of the invention with the engine able to complete the process (1004) without further financial information or PIN entry, is unique.

Electronic service/retailer 1010 may sell electronic products or may sell physical products, or may offer services either remotely or at the location of the customer or vendor. The vendor will have a checkout page (XML, etc) 1012 which will serve as the interface between the portal and the customer, or between the customer and the engine 1004 or other combinations as needed. This webpage may be embedded in the portal 1002 instead of in the retailer's website, or could be located elsewhere. The portal may be a server, obviously.

Consumer/buyer 1014 (represented by their electronic personal device: a tablet, PC, tablet PC, phone, laptop, desktop, terminal, etc etc etc) has a browser 1016 (which supports XML, etc, so as to use the webpage 1012). Note that the physical transfer of item/perform service 1018 may occur as an integral part of the method of using the device of the invention.

Camera 1020 need NOT be specialized “facial recognition” camera, however, it may be. Such specialized cameras offer multi-dimensional scans, uniform lighting, etc, however, the normal camera built into personal devices is rapidly approaching or already has more than adequate performance specs to be used with the device of the invention. For multi-dimensional scans an ordinary camera might be used with specific instructions to the user to change their position to meet feedback criteria of the portal or app, or to move the phone according to set instructions, etc.

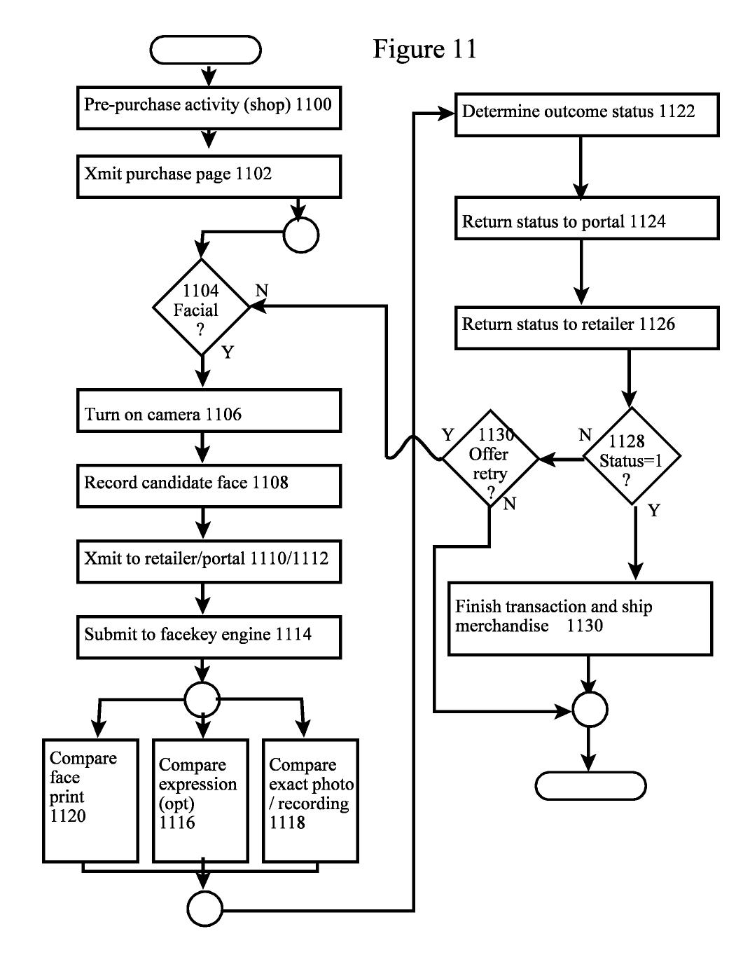

FIG. 11 is a flow chart of the purchase operations of the system/apparatus and also of the method embodiment of the invention. This method may require use of the device of the invention, or it may be an embodiment which does not require the device of the invention.

It is important to understand that the device of the invention can stand on its own without this particular method of use, nor any of the equivalents and substitutions which are covered herein. Rather, the device of the invention (see for example FIG. 9) is itself an independent machine.

Pre-purchase activity (shopping, browsing) 1100 leads to the transmission of the purchase page (in HTML, XML, JAVA, FLASH, etc) 1102 and then to a purchase decision, consumer choice 1104 whether and what to purchase.

Turning on the camera (1020) is step 1106 of this embodiment, followed by recording or imaging of a facial identity code candidate 1108, that is, in essence, the user taking a selfie. This candidate may in simplified embodiments require the user to doff glasses, adopt a neutral mien, keep their head vertical and straight and hold the camera at a set location(s), or in more advanced embodiments none of this may be necessary.

The app or portal of the invention may then either use the raw image as a candidate security code for transmission or it may process it according to simple or complex algorithms or standards. It might compress the image, or run it through a hash table, or perform more specialized facial recognition functions such as determining certain landmarks or tones, etc.

The candidate security code is then transmitted, step 1110. This transmission may be to the retailer, allowing the retailer to retain a uniform look and feel to their electronic purchase process, or it may be directly to the portal, the engine, etc.

If it went to the retailer it is then forwarded to the portal, step 1112, and submitted to the engine for testing at step 1114. This testing may consist of a comparison of the derived facekey or the complete image as facekey: the candidate code is in any case compared to the facial data in the record.

Note that some possible alternative and complementary routes of comparison are possible. It is possible to compare a face expression to the face expression associated with customer identity 1116 as an anti-fraud or customer protection measure. It is also possible to do an anti-fraud check for comparison of an actual photographic faceprint to faceprint associated with customer identity 1118, that is, checking to see if the person holding the personal electronic device is merely transmitting a photograph of the actual user. Finally, obviously the actual comparison of the biometric faceprint of the candidate to the faceprint associated with the customer identity, step 1120, is necessary for the invention. These alternatives may be pruned to only step 1120 or expanded upon in other embodiments of the invention.

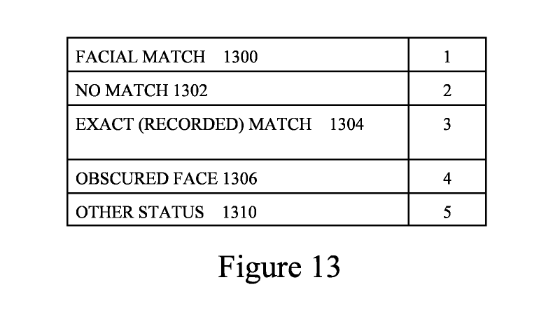

The next step is the determination of the test outcome, and setting a flag status 1-5, at step 1122. These statuses will be discussed further in reference to FIG. 13.

The status is returned to the portal/retailer/app at step 1124, or returned from the portal to the retailer (1126).

The retailer may have on file in the engine/portal a list of acceptable statuses, or the retailer may have a system to determine what status is acceptable in each case.

If the status is acceptable to the retailer (check step 1128) then the transaction is completed at step 1130. This may occur in the retailer's store, for example by returning from the device of the invention the financial information 902, or it may occur in the engine 906, etc.

Complete transaction 1130 refers to the physical transmission of an object.

Note that sometimes an individual will fail, in which case depending on the status of the fail the method of the invention may offer a retry at step 1132.

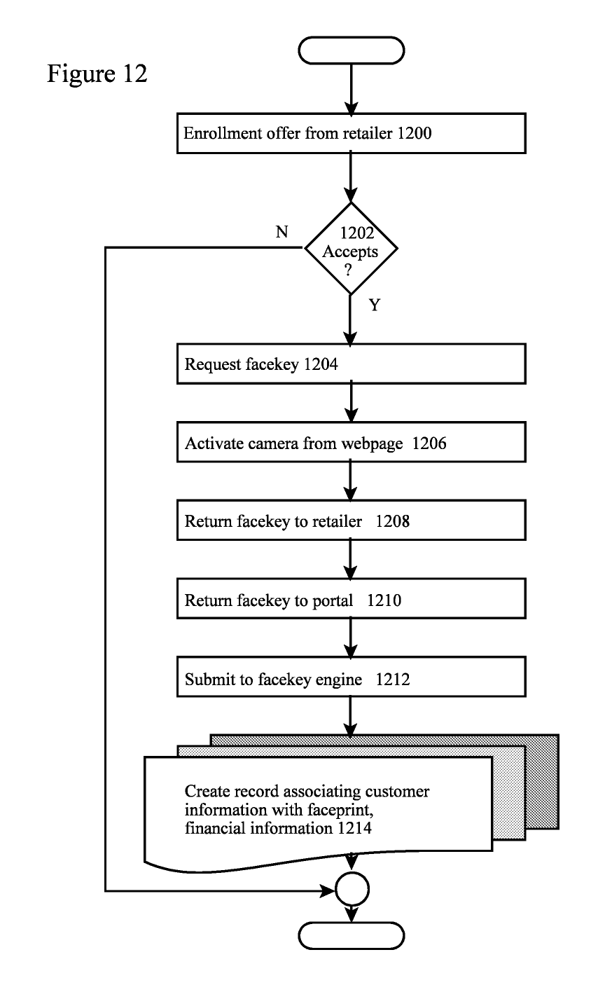

FIG. 12 is a flow chart of the registration process of the system/apparatus and also of the method embodiments of the invention.

Registration offer from retailer/portal 1200 allows a consumer decision 1202 whether they wish to be part of the convenience system. If they customer wishes to register then the system will request a face identity code 1204, that is, a first image or first set of images for the database 904. Activate camera step 1206 (take a picture) leads to return of the face identity code to the retailer/portal/engine 1208 (and/or return face identity code to portal 1210) and submission to the facekey engine 1212. The database financial information and faceprint are then associated with the consumer's identity 1214.

FIG. 13 is a table of flags returned by the invention to a retailer, showing the outcome of face key testing.

Words and voice match, status 1, 1300, is the best result, allowing release or use of the customer financial data and immediate processing of the transaction.

No match, status 2, 1302 prevents a transaction and may or may not, at retailer or portal discretion, offer a retry.

EXACT (photographic) match, status 3, 1304 might cause the retailer to refuse to offer a retry and to immediately contact law enforcement or a backup contact s of the customer found in the database record 902/904.

Obscured face, status 4, 1306 on the other hand might cause the retailer to send the customer a signal, “Face obscured, please remove facial coverings and try again.”

Other statuses may exist, as shown by status 5+, flag condition 1310, which may be used for alternative embodiments of the system.

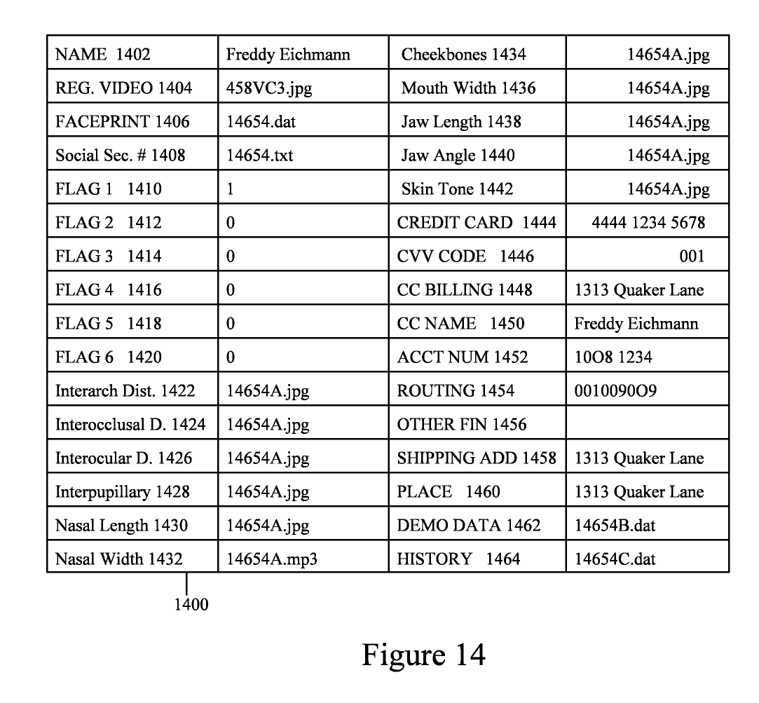

FIG. 14 is a simplified black diagram of an individual customer record according to the invention. This embodiment of the individual record is greatly simplified, being static and having in some places references to other records. It will be noted that the combination of facekey information and financial information is complete: both types of information (902, 904) are present but in this and many embodiments they are seen to be stored together, or mixed as needed, etc.

Record 1400 will have the customer's name 1402, their registration faceprint 1404 (which is much more likely to be a video composed of numerous single frame images) and then faceprint id information 1406 which may be considered to be a compression, hash or distillation of the entire image into a smaller, faster processing, form, rather like the extremely simplified form shown in FIGS. 7 and 8, a statistical file, a 3D model or almost any other form found to be usable.

ID information 1408 may be any legally permitted identity information such as a driver's license number, passport number, “A” number or the like. Status flags 1410-1420 may help to track a customer's status of usage: these may represent data on the individual, their transactions, their patterns of use, potential dangers, etc.

A large number of facial recognition data points may be present in the record, instead of the facekey 1406 or in addition to it: interarch distance 1422, ineroccuclusal distance 1424, interoccular distance 1426, interpupillary distance 1428, nose length 1430, nasal width 1432, cheekbone shape (left) 1434, mouth width 1436, jaw length 1438, jaw angle 1440, skin tone 1442, and considerably more.

The financial information is also present: credit card number 1444, credit card security codes 1446, credit card billing address 1448, credit card name 1450, bank account number 1452, bank routing number 1454, other financial data 1456, and so on.

Additional “financial” data necessary to transaction may be provided, so that a customer need not even enter these at the time of shopping: a shipping address 1458, a performance-of-service address 1460, demographic data 1462, electronic commerce history 1464 and more.

Throughout this application, various publications, patents, and/or patent applications are referenced in order to more fully describe the state of the art to which this invention pertains. The disclosures of these publications, patents, and/or patent applications are herein incorporated by reference in their entireties, and for the subject matter for which they are specifically referenced in the same or a prior sentence, to the same extent as if each independent publication, patent, and/or patent application was specifically and individually indicated to be incorporated by reference.

Methods and components are described herein. However, methods and components similar or equivalent to those described herein can be also used to obtain variations of the present invention. The materials, articles, components, methods, and examples are illustrative only and not intended to be limiting.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

Having illustrated and described the principles of the invention in exemplary embodiments, it should be apparent to those skilled in the art that the described examples are illustrative embodiments and can be modified in arrangement and detail without departing from such principles. Techniques from any of the examples can be incorporated into one or more of any of the other examples. It is intended that the specification and examples be considered as exemplary only, with a true scope and spirit of the invention being indicated by the following claims.

We claim:

1. A transactional device for a customer having a personal electronic device having a camera, the device comprising:
a customer record having:
1) electronic facial recognition identity data of such customer;
2) associated with such facial recognition identity data, commercial information sufficient to complete an electronic purchase transaction,
3) a purchase processor able to receive contemporaneous facial data from such personal electronic device camera and then to complete the electronic purchase transaction using only the commercial information in the record without additional financial data being required.

2. The transactional device of claim 1, wherein:
the customer record is one entry in a database having a plurality of customer records;
the transactional device and database are embodied in a machine readable and
non-volatile medium accessible to a computer processor;
the transactional device is electronically remotely accessible.

3. The transactional device of claim 2, further comprising:
a facial comparison module operative to compare:
1) a facial identity code candidate provided by such customer from such personal electronic device camera and at a time of purchase to:
2) the electronic facial recognition identity data of such customer.

4. The transactional device of claim 1, further comprising:
an electronic purchase device, the purchase processor embedded upon such electronic purchase device,
wherein the electronic purchase device further comprises:
one member selected from the group consisting of: the purchase page of the electronic retailer; the website of the electronic retailer; a purchase page provided by the biometric facekey engine; a dedicated POS station of the electronic retailer; an electronic browsing device of the electronic retailer having thereon POS programming; a vending machine; a dedicated purchase kiosk and combinations thereof.

5. A method of electronic commerce offered by retailer having an electronic purchase device, for use by a customer having an electronic browsing device having a camera, the method comprising the steps of:
providing a database having a plurality of records, each record associated with a single customer, each record having commercial information associated with such customer which commercial information is sufficient to complete a purchase transaction;
each record further having biometric facial identity information associated with such customer;
providing a product/service for purchase by such customer;
transmitting to such customer a purchase page of such retailer;
offering such customer the option of facekey checkout and proceeding with the following steps if the customer elects facekey checkout
activating such camera on such customer's electronic browsing device;
recording the customer's facial identity code candidate;
transmitting the facial identity code candidate to a facial checkout portal;
submitting the facial identity code candidate to a biometric facekey engine for testing;
comparing the facial identity code candidate to the biometric facial identity information associated with such customer in the database;
based upon the results of the comparisons of the facial identity code candidate to the biometric facial identity information associated with such customer, assigning a test outcome status to the identity code candidate;
determining if the test outcome status is acceptable to such retailer;
if the test outcome status is acceptable to such retailer, completing a purchase using the commercial information associated with such customer, including providing the service/shipping the product;
if the test outcome status is not acceptable to such retailer, determining if the test outcome status merits raising a fraud detection flag;
if the test outcome status does not merit raising a fraud detection flag, determining if such retailer wishes to offer such customer a chance to retry the facekey checkout and if so, returning to the step of offering such customer the option of facekey checkout.

6. The method of claim 5, further comprising the first step of:
embedding upon such electronic purchase device a facekey recognition module.

7. The method of claim 6, wherein such electronic purchase device further comprises:
one member selected from the group consisting of: the purchase page of the retailer; the website of the retailer; a purchase page provided by the biometric facekey engine; a dedicated POS station of the retailer; an electronic browsing device of the retailer having thereon POS programming; a vending machine; a dedicated purchase kiosk and combinations thereof.

8. The method of claim 5, wherein the step of determining if the test outcome status is acceptable to such retailer further comprises:
returning the test outcome status to such retailer for such determination of acceptability to such retailer.

9. The method of online commerce of claim 5, wherein the step of providing a database having a plurality of records, further comprises:
providing an online commerce site;
providing a registration process in turn comprising the steps of:
offering to such customer the opportunity to register for facekey checkout;
if such customer accepts the opportunity to register for facekey checkout, creating the record associated with such customer;
obtaining from such customer the customer's commercial information and associating that commercial information with such customer in the record;
activating such camera on such customer's electronic browsing device;
recording biometric facial identity information;
transmitting to the facekey checkout portal the biometric facial identity information;
associating the biometric facial identity information with such customer in the record,
including with the customer's commercial information.

10. The method of online commerce of claim 9, further comprising the step of associating an exact recording information of the biometric facial identity information with such customer in the record, and wherein the step of comparing the biometric facial identity information further comprises comparing exact image recording information of the facial identity code candidate to the exact facial identity code candidate information associated with such customer.

11. The method of online commerce of claim 10, wherein the test outcome status is one member selected from the group consisting of: a first status of match, a second status in which there is no match, a third status in which there is an exact image match, a fourth status in which such customer's facial identity code candidate included an obscured face, and combinations thereof.

12. The method of online commerce of claim 5, wherein the biometric facial identity information further comprises: a complete record of the biometric facial identity information, a hash of the biometric facial identity information, compressed/encoded biometric facial identity information, parity bit checking of the biometric facial identity information, and combinations thereof.

13. The method of online commerce of claim 5, wherein the commercial information associated with a customer further comprises one member selected from the group consisting of: credit card number, credit card security codes, credit card billing address, credit card name, bank account number and routing number, other financial data, shipping address for the aforementioned physical step of shipping the product, performance address for the aforementioned physical step of performing a service, demographic data, electronic commerce history and combinations thereof.
